(19) United States
(12) Patent Application Publication
(10) Pub. No.: US 2006/0174730 A1
(43) Pub. Date: Aug. 10, 2006

(54) Wrench improvment

(76) Inventor: Denis Lee Stewart, Waiuku (NZ)

Correspondence Address: O M Sam Zaghmout;Bio Ips, 8509 Kernon Court, Lorton, VA, 22079, US

(21) Appl. No.: 10/547,698

(22) PCT Filed: Feb. 27, 2004
(86) PCT No.: PCT/NZ04/00038

§ 371 Date: Sep. 2, 2005

(30) Foreign Application Priority Data
Mar. 2, 2003 (NZ) 522889

(51) Int. Cl. B25B 13/28

(52) U.S. Cl. 81/98

(57) ABSTRACT

An adjustable wrench as in FIG. 1 whereas the wrench head (2) has new Jaw teeth (1) formed on the upper inclined surface (4) of the jaw to make the wrench be able to fit smaller shapes and sizes of pipe (6) and nuts (7). These teeth and formed in a shape of a Peaking wave for strength and to act as a claw or anchoring point so as the grip is always coming from a single strong sharp gripping point that is at the further most point on the object being gripped.

### TECHNICAL FIELD

This invention relates to a wrench. A preferred form of the invention involves an adjustable wrench used for tightening and loosening nuts and pipes, or for gripping and turning objects generally. It should however be understood that the invention is not limited to such.

### BACKGROUND

At least some known wrenches suffer from a restriction in terms of their object size capabilities. This means that one may have to change to a smaller wrench to grip smaller objects, etc. The inventor has found that jaw gripping points in the form of jaw teeth can be added to an inclined surface of a movable jaw member of a wrench allowing the wrench to grip smaller objects than would otherwise be the case. Further aspects and advantages of a preferred embodiment of the present invention will become apparent from the ensuing description, which is given by way of example only.

### SUMMARY OF THE INVENTION

According to one aspect of the invention there is provided a wrench comprising a handle, a first jaw forming a fixed end part of the handle, and a second jaw, the second jaw being moveable with respect to the first jaw to enable gripping surfaces of the jaws to move towards one another and then away from one another so as to cause the jaws, when in use, to grip and then release an object respectively, the gripping surfaces of the second jaw having a series of generally rounded wave shaped outer teeth and an inner tooth or teeth, the inner tooth or teeth being in the form of a substantially peaking wave or beak and arranged such it/they can engage smaller work pieces more effectively than is possible by way of the outer teeth.

Preferably the first jaw has a series of teeth generally facing the outer teeth and the inner tooth or teeth of the second jaw.

Preferably the first jaw has a series of substantially uniform teeth generally facing the second jaw.

Preferably the first jaw has a series of substantially uniform teeth extending around a curved end part of the first jaw and generally facing the second jaw.

Preferably the second jaw has a tongue, and the tooth or teeth which is/are in the form of a substantially peaking wave or beak is/are immediately adjacent the tongue.

Preferably the second jaw has a tongue, the tooth or teeth which is/are in the form of a substantially peaking wave or beak are immediately adjacent the tongue, and wherein the handle has a measurement scale to enable the handle to function as a ruler.

According to a further aspect of the invention there is provided a wrench comprising a handle, a first jaw forming an end part of the handle, and a second jaw which has a tongue, the second jaw being attached to the rest of the wrench by way of the tongue, the second jaw being moveable with respect to the first jaw to enable gripping surfaces of the jaws to move towards one another and then away from one another so as to cause the jaws, when in use, to grip and then release an object respectively, a gripping surface of the second jaw having a series of outer teeth and an inner tooth or teeth, the inner tooth or teeth being immediately adjacent the tongue and arranged such it/they can engage smaller work pieces substantially more effectively than is possible by way of the outer teeth of the second jaw. Preferably the first jaw forms a fixed end part of the handle.

Further aspects of the present invention will become apparent from the ensuing description, which is given by way of example only and with reference to the accompanying drawings.

### BRIEF DESCRIPTION OF THE DRAWINGS

A preferred embodiment of the invention will now be described with reference to the accompanying drawings in which:

FIG. 1: is a side view of a wrench head showing the wrench gripping an object by way of jaw teeth,

FIG. 2: shows the wrench of FIG. 1 with jaws opened to release the object,

FIG. 3: is side view of the wrench head showing the wrench in use gripping a nut, and

FIGS. 4-7: are side views of wrenches in accordance with the invention demonstrating various wrench size options (4, 6, 8 and 10″) and arrangements of jaw teeth,

### DETAILED DESCRIPTION

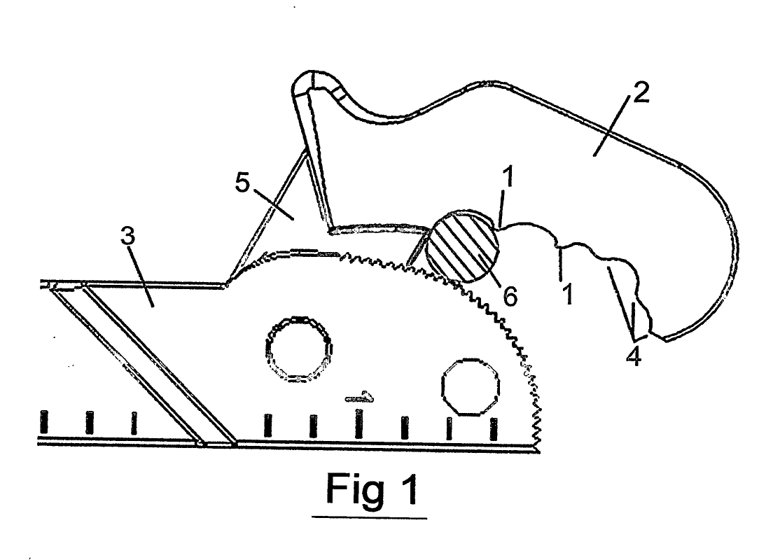

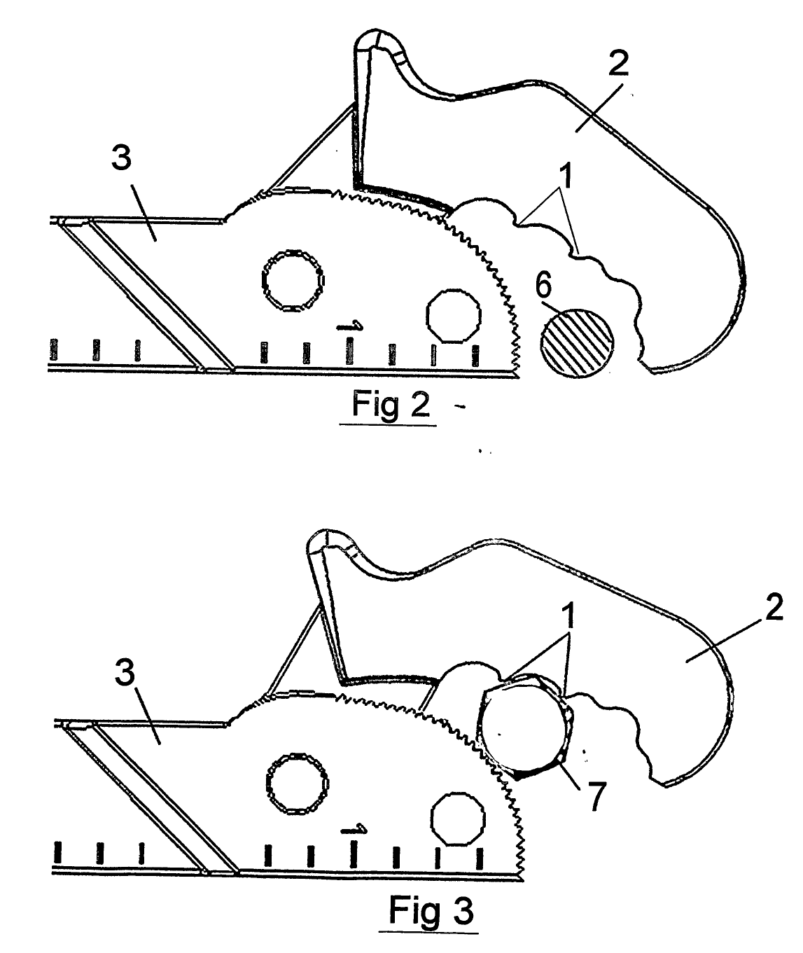

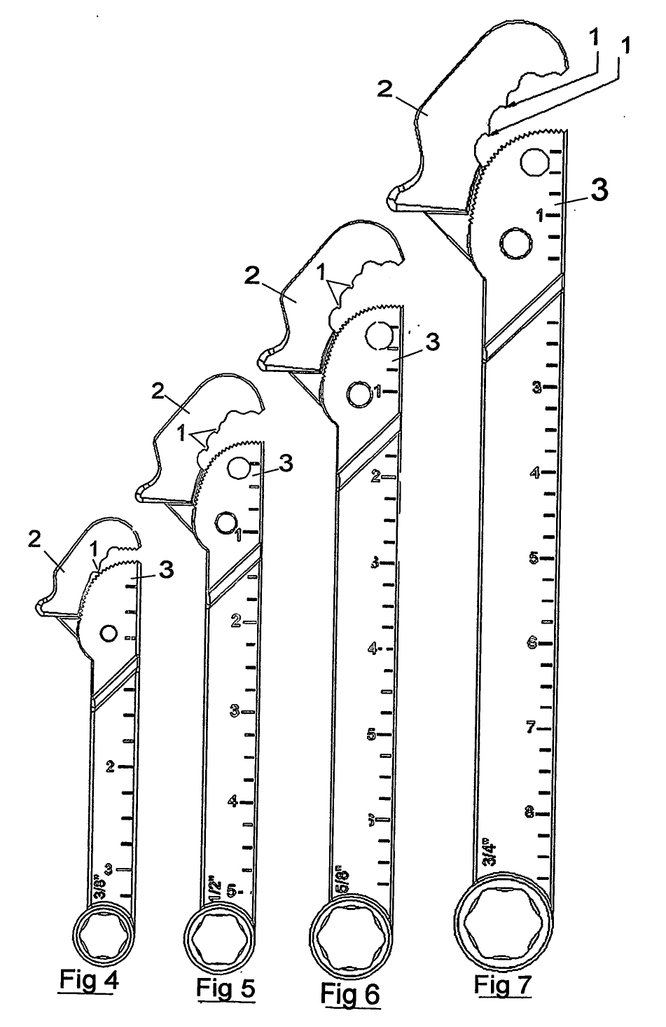

With reference to FIG. 1 there is shown the head of a wrench according to a preferred embodiment of the present invention. The wrench comprises an elongate handle member 3 (only part of which is visible in FIG. 1) and a movable jaw member 2. The movable jaw member 2 is generally formed with outer gripping surfaces/teeth 4 together with inner gripping surfaces/teeth 1. As shown, the inner gripping surfaces 1 are adjacent an inclined tongue portion 5 forming part of the moveable jaw member 2.

The inner gripping surfaces 1 are generally formed in the shape shown in the drawings or with an alternative shape suitable for achieving a good grip on a work piece 6. As shown, the inner gripping surfaces/teeth 1 are generally in the form of peaking waves or beaks, and the outer gripping surfaces/teeth are in the form of generally rounded waves. Preferably the inner gripping surfaces are shaped in such a way as to make them less likely to damage pipes 6 (see FIG. 1) and nuts 7 (see FIG. 3). As shown in FIG. 1, the inner gripping surfaces 1 are preferably formed as a pair of teeth.

The teeth of the inner gripping surfaces 1 are preferably manufactured using dyes and by a wire cut copper electrode. The electrode may be used to spark the dyes to the desired shape so as to form the target end products. The wrench may be formed by dye casting or drop forging. Some preferred embodiments of the invention enable advantages selected from the following list (which should not be taken as imposing a limitation on the scope of the invention as claimed):
i) The use of the inner gripping surfaces/teeth enables the wrench to accommodate smaller objects (eg bolts or pipes of various shapes) than would otherwise be the case.
ii) The shape of the inner gripping surfaces/teeth 1 is such that they may cause only negligible damage to objects which are gripped thereby while still enabling a strong grip.
iii) The inner gripping surfaces/teeth 1 may be suitably spaced to allow for increases in the shape and size of objects gripped while enabling a strong grip.

While some preferred forms of the invention have been described by way of example it should be appreciated that modifications and improvements can occur without departing from the scope of the following claims.

1-4. (canceled)

5. A wrench comprising a handle, a first jaw forming a fixed end part of the handle, and a second jaw, the second jaw being moveable with respect to the first jaw to enable gripping surfaces of the jaws to move towards one another and then away from one another so as to cause the jaws, when in use, to grip and then release an object respectively, the gripping surfaces of the second jaw having a series of generally rounded wave shaped outer teeth and an inner tooth or teeth, the inner tooth or teeth being in the form of a substantially peaking wave or beak and arranged such it/they can engage smaller work pieces more effectively than is possible by way of the outer teeth.

6. A wrench according to claim 5, wherein the first jaw has a series of teeth generally facing the outer teeth and the inner tooth or teeth of the second jaw.

7. A wrench according to claim 5, wherein the first jaw has a series of substantially uniform teeth generally facing the second jaw.

8. A wrench according to claim 5, wherein the first jaw has a series of substantially uniform teeth extending around a curved end part of the first jaw and generally facing the second jaw.

9. A wrench according to claim 5, wherein the second jaw has a tongue, and the tooth or teeth which is/are in the form of a substantially peaking wave or beak is/are immediately adjacent the tongue.

10. A wrench according to claim 5, wherein the second jaw has a tongue, the tooth or teeth which is/are in the form of a substantially peaking wave or beak are immediately adjacent the tongue, and wherein the handle has a measurement scale to enable the handle to function as a ruler.

11. A wrench comprising a handle, a first jaw forming an end part of the handle, and a second jaw which has a tongue, the second jaw being attached to the rest of the wrench by way of the tongue, the second jaw being moveable with respect to the first jaw to enable gripping surfaces of the jaws to move towards one another and then away from one another so as to cause the jaws, when in use, to grip and then release an object respectively, a gripping surface of the second jaw having a series of outer teeth and an inner tooth or teeth, the inner tooth or teeth being immediately adjacent the tongue and arranged such it/they can engage smaller work pieces substantially more effectively than is possible by way of the outer teeth of the second jaw.

12. A wrench according to claim 11, wherein the first jaw forms a fixed end part of the handle.
